(19) United States
(12) Patent Application Publication
(10) Pub. No.: US 2012/0123800 A1
(43) Pub. Date: May 17, 2012

(54) PATIENT MONITORING SYSTEM HAVING A PATIENT HISTORY SLIDER

(76) Inventors: Geoffrey Clapp, Sunnyvale, CA (US); Sudhir Durvasula, Fremont, CA (US)

(21) Appl. No.: 12/948,217

(22) Filed: Nov. 17, 2010

(51) Int. Cl. G06Q 50/00

(52) U.S. Cl. 705/3

(57) ABSTRACT

A patient monitoring system designed to monitor a patient located in a home or residence and to provide information to a health care manager located at a healthcare facility. The system includes a base station configured to be located at a residence or home of a patient. The base station has an input for receiving physiological measurements from sensor connected to a patient. A computer system located remotely from the patient's home or residence receives information from the base station over a network. The computer system performs an automated risk assessment of the physiological data, and generates a graphical user interface having a patient history slider. The computer system, in response to movement of the slider, updates a session time frame, updates a trend of physiological measurements, and updates the results of an automated risk assessment.

### BACKGROUND

The present invention relates to patient monitoring systems. More particularly, the invention relates to systems that are used to monitor the vital signs of patients in their homes to assist healthcare or clinical professionals (e.g., doctors, nurses, and the like) in managing the care of patients remotely.

A number of remote, patient monitoring systems designed to monitor an aspect of a patient's health from the patient's home are known, including systems manufactured by, for example, Health Hero Network, Intel, Tunstall, and Honeywell. In general, these systems are used to monitor the vital signs of patients at home and to support care management. Often, these systems work as follows: the patient measures his vital signs and additionally answers an electronic questionnaire using one or more devices located in the patient's home. A set of data including the measured vital signs as well as the answers to the questions in the survey is called a “session.” The session is transmitted to a computer system of the healthcare provider and accessible by the clinical professionals.

### SUMMARY

An important aspect of patient monitoring systems designed for use in the home is a web-based (or accessible) application that generates a graphical user interface. The clinical professionals who care for the patients (sometime referred to as “care managers”) can log into the web-based application in order to monitor, analyze, and evaluate the data or session sent by the patient to the healthcare provided. In some instances, processing of the session is performed by the healthcare provider's computer system to assist the care providers in performing an evaluation. For example, in some prior systems, critical values are highlighted or marked using different colors.

While, the highlighting and color-coding provided in prior systems is helpful to care managers, the usability of many systems is less than desired because care managers must review large amounts of patient data (for example, one session, per patient for each day of the year). Navigating through the data for numerous patients is difficult even with highlighting and color-coding.

Thus, the invention provides, among other things, a navigation tool in the form of a patient history slider. The patient history slider allows a care manager to rapidly analyze large amounts of data by automatically updating information in various windows in the graphical user interface in accordance with the period of time selected by the care manager using the slider.

In one embodiment, the invention provides a patient monitoring system designed to monitor a patient located in a home or residence and to provide information to a health care manager located at a healthcare facility. The system includes a base station configured to be located at a residence or home of a patient and having an input that receives physiological measurements from a patient. A computer system is located remotely from the patient's home or residence and receives information from the base station over a network. The computer system performs an automated risk assessment of the physiological data, and generates a graphical user interface having a patient history slider. The computer system, in response to movement of the slider, updates a session time frame, updates a trend of physiological measurements, and updates the results of an automated risk assessment.

Other aspects of the invention will become apparent by consideration of the detailed description and accompanying drawings.

### BRIEF DESCRIPTION OF THE DRAWINGS

FIG. 1 is a schematic illustration of a patient monitoring system including a base station designed to be used by a patient at his or her residence or home, a server or similar computer, and a workstation or similar computer system located at a healthcare facility and accessible by a care manager.

FIG. 2 illustrates a patient overview page from a graphical user interface presented on a display device at the workstation located at the healthcare facility (illustrated in FIG. 1).

FIG. 3 is enlarged illustration of a patient history slider from the patient overview page illustrated in FIG. 2.

FIG. 4 illustrates a portion of the patient overview page of FIG. 2 in which a care manager has selected a session information window for viewing.

FIG. 5 illustrates a second portion of the patient overview page from FIG. 2 in which a care manager has selected a vital signs information window for viewing.

FIG. 6 is a flow diagram illustrating processes carried out by a computer (such as the server or workstation illustrated in FIG. 1) on which a monitoring, analysis, and evaluation application is installed.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of being implemented in other embodiments and of being practiced or of being carried out in various ways.

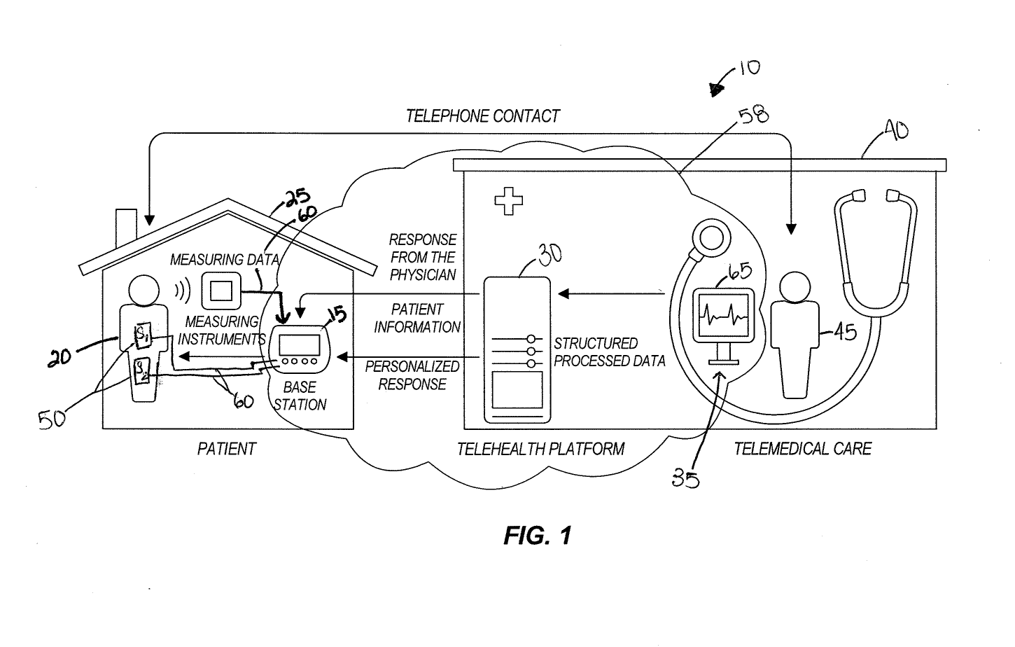

FIG. 1 illustrates one embodiment of a patient monitoring system 10 used to monitor the vital signs of a patient. The system 10 generally includes a base station 15 (e.g., a computer system) designed to be used by a patient 20 in his or her residence or home 25, a server 30, and a workstation 35 located at a health care facility 40 (e.g., hospital, health clinic, etc.). The server 30 maybe located at the healthcare facility or a different location, such as a remote hosting location. The workstation 35 (e.g., a computer system) is accessible by a clinical professional or care manager 45 at the health care facility 40. A health care facility 40 can have and operate multiple workstations 35 that are incorporated into to the patient monitoring system 10.

In the embodiment shown in FIGS. 1-6, patient 20 uses various measuring instruments (represented by sensors S₁ and S₂) 50 to measure their vital signs (e.g., blood pressure, glucose level, weight, etc.). Information can be sent from various physiological sensors wirelessly to the base station 15. In addition, patients 20 answer an electronic medical questionnaire using the base station 15. The patients' vital signs (or physiological data) and the answers to the questionnaire comprise patient measuring data 60 that is collected by the base station 15. As shown in FIG. 1, the base station 15 transmits the patient measuring data 60, over a network 58, to a workstation 35 where that data is evaluated by a care manager. The network 58 connects the base station 15, the server 30, and work station 35. Every collection and transmission of measurement data 60 from the base station 15 to a workstation 35 is considered a new “session” by the system 10.

The workstation 35 includes typical hardware such as a microprocessor or similar device, I/O interfaces, and storage devices or memory. The workstation 35 also includes input devices such as a keyboard and a mouse, and output devices, such as a monitor. In addition, the workstation 35 can include peripherals, such as a printer, a scanner, and a camera. The workstation 35 can include one or more software programs or modules that operate to communicate with the patient monitoring system 10. For example, in one embodiment the workstation includes browser software which is used to access an analysis application (discussed below) installed on server 30.

The network 58 can be built according to existing networking technology or topology or combinations of technologies and topologies and can include multiple sub-networks. Connections between the computers and systems shown in FIG. 1 can be made through local area networks (“LANs”), wide area networks (“WANs”), public switched telephone networks (“PSTNs”), wireless networks, Intranets, the Internet, or other suitable networks.

Generally, a case manager 45 logs into a web-accessible analysis application (running on the server 30) in order to monitor, analyze, and evaluate the measuring data sent by the patients 20. The workstation 35 presents an automated risk assessment of the physiological data included in the measuring data 60. After the care manager analyzes the measuring data 60, the care manager can communicate with the patient 20 by telephone or other mechanism (e.g., via email or chat).

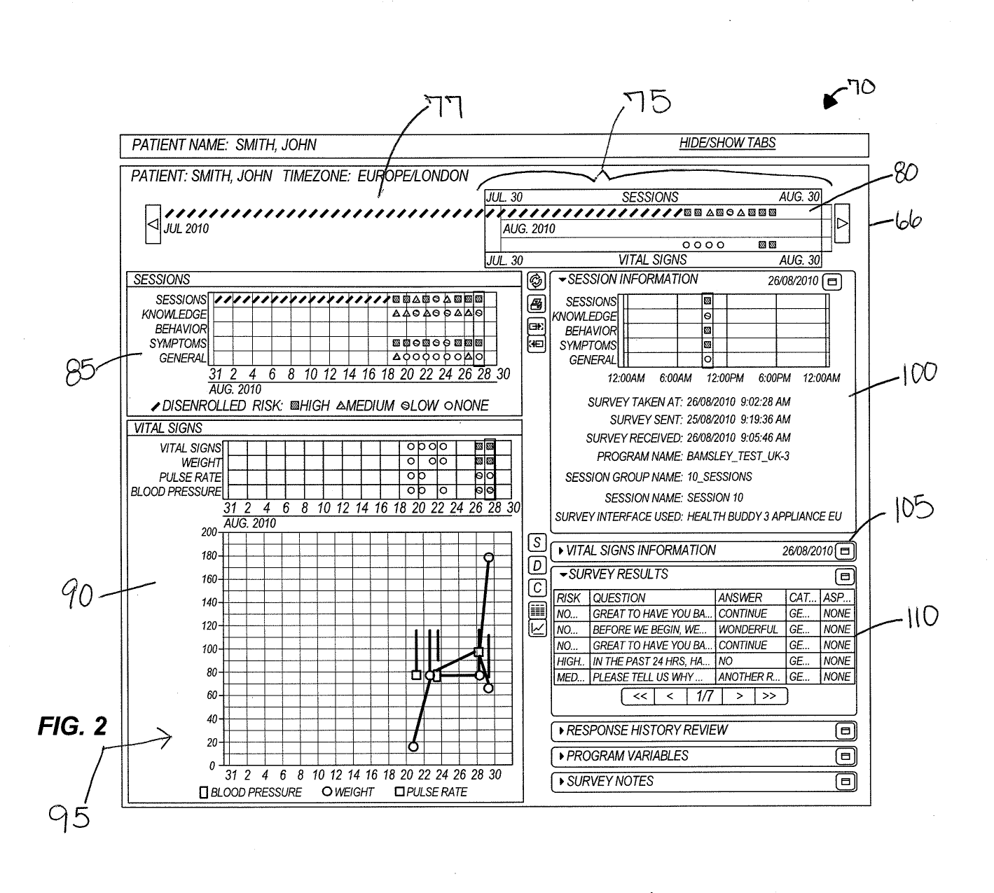

The workstation 35 includes a display device 65 (e.g., a monitor or a screen). FIG. 2 illustrates an example of a patient overview page 66 from a graphical user interface 70 presented on the display device 65 at the workstation 35. The patient overview page 66 is viewed by the care manager 45 and includes information about the patient, his or her medical history, and the automated risk assessment based on the measurement data received during a session. The patient overview page 66 can include the patient's name, location, date of the current or last session being displayed, and other information. The patient overview page 66 also includes a patient history slider 75 positioned on a time line 77, a session overview window 85, a vital sign overview window 90 having a vital sign trend graph 95, a session information window 100, a vital sign information window 105, and a survey results information window 110. The windows 85, 90, 95, 100, 105, and 110 are all part of the graphical user interface. Additional windows (e.g., survey notes, program variables, response history review, etc.) can also be created and displayed on the patient overview page 66.

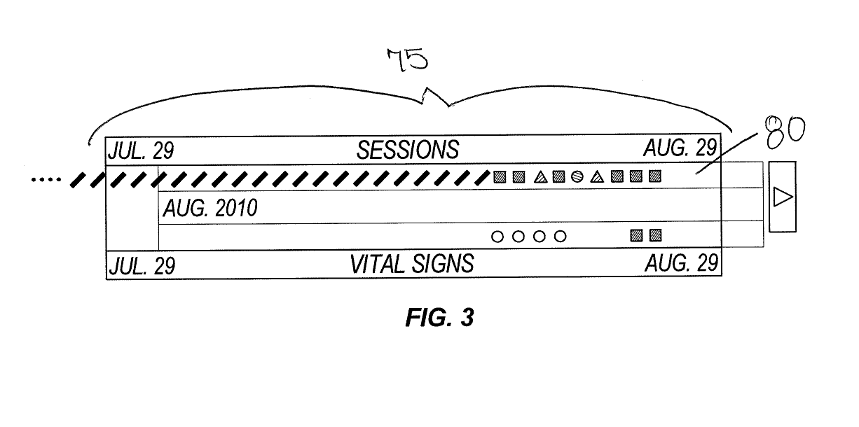

The patient history slider 75 provides a mechanism (analogous to a mechanical slider) that allows a user to navigate through sessions and information regarding the patient's vital signs received from the base station 15. A user can scroll or move the patient history slider 75 left or to the right using a mouse or other input device. As illustrated in FIG. 3, the patient history slider 75 includes or contains a plurality of symbols 80 in a first row 82 that illustrate the results of the automated analysis and risk assessment performed by the system for a day. Even if a patient is disenrolled on a particular day but the system receives measurement data from the patient (e.g., a morning session), a risk assessment will be created and displayed from that day. The automated risk analysis in the first row 82 of the slider shows the overall patient risk for the day and includes all categories of data submitted by the patient (i.e., the vital signs and the answers to the questionnaire). For example, the symbols can include: a diagonal slash (symbolizing or representing no data submitted when the patient is disenrolled that day), a dash (symbolizing or representing no response to a survey), a red square (symbolizing or representing a critical risk), a yellow triangle (symbolizing or representing a medium risk), a green circle (symbolizing or representing a low risk), a white circle with black border (symbolizing or representing no risk), and a blank space (indicating or representing that the patient is still enrolled in the system but that no survey was sent to the patient) (in other words, the blank space provides an indicates about whether the patient has submitted information). Other symbols can also be created and used. The second row 83 of the history slider 75 illustrates the results of the automated analysis of the data from the patient's vital signs only. In response to movement of the slider 75, the system 10 is configured to update a session time frame, update the trend of physiological measurements, and update the results of the automated risk assessment.

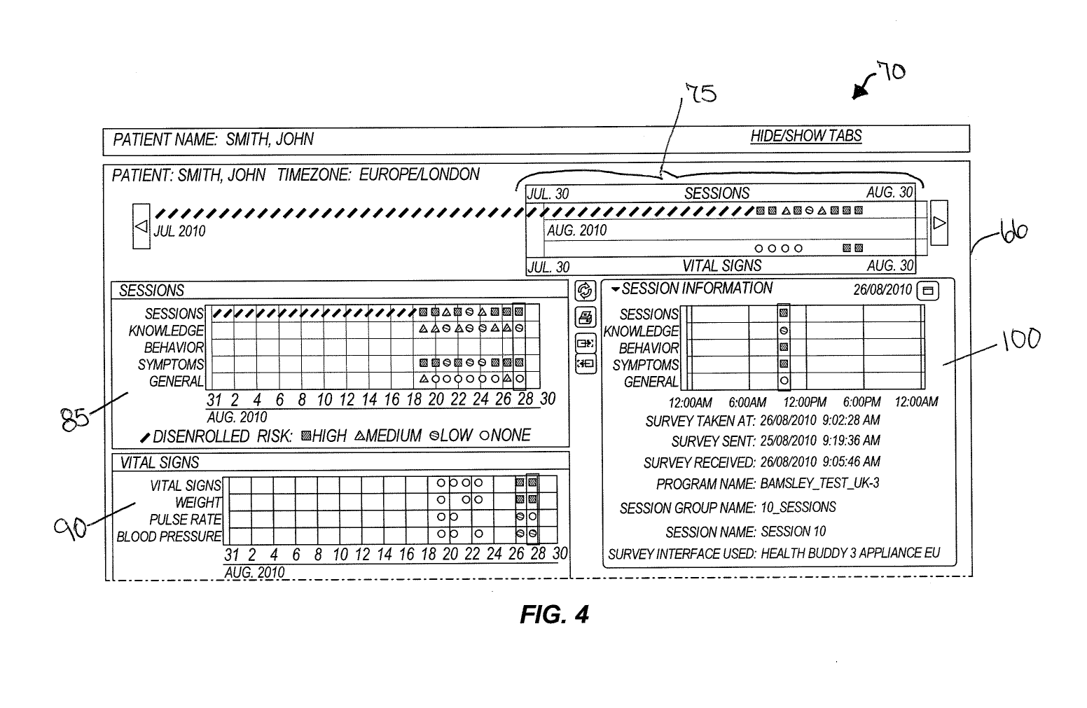

FIG. 4 illustrates an example of the patient overview page 66 where a case manager reviews the results of the automated analysis of the submitted patient's data for a time frame selected by the history slider (e.g., a day). During such a review, the patient overview page 66 displays the patient history slider 75 that shows the aggregated risk of all sessions collected for a particular day and the aggregated risks of all gathered vital signs for that day. The vital sign overview window 90 shows the highest risk for each vital sign for a day. In addition, the session risk overview window 85 shows daily session risks, including specific categories of risks for a day. The session information window 100 provides a session risk for each individual session taken on that day with detailed session information (e.g., vital signs measured, questions answered, etc.). Thus, the session information window 100 and the vital sign information window 105 (not shown in FIG. 4) show the breakdown of data submissions so that the highest overall risk for a day shown in the patient history slider 75 can be tracked to the exact data point and time.

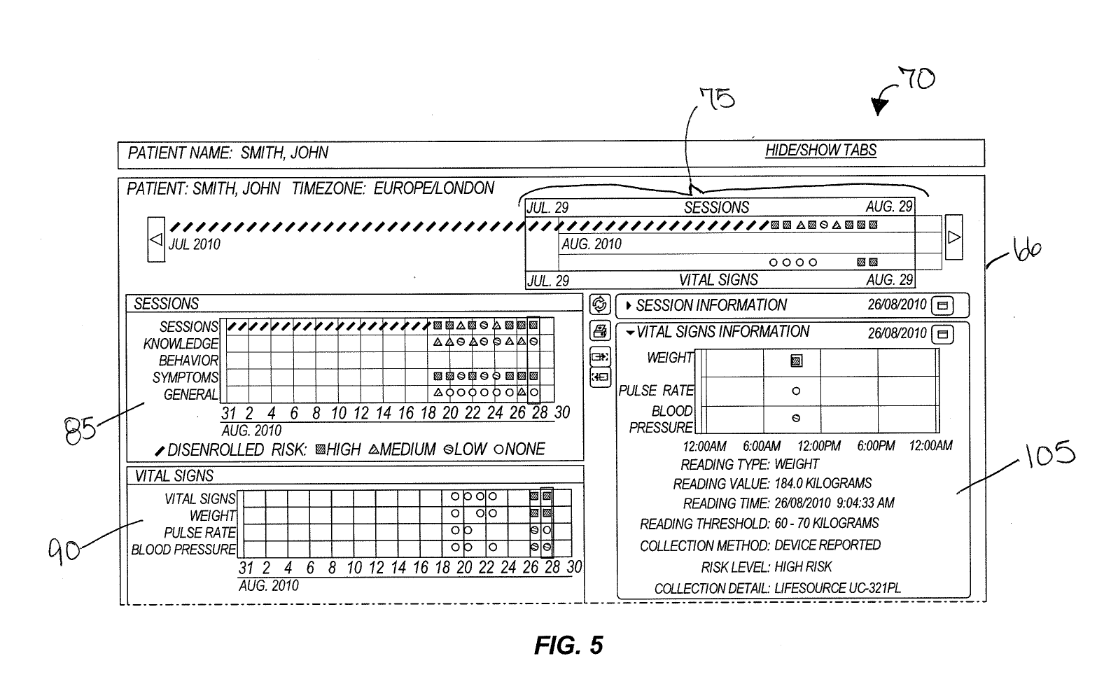

FIG. 5 illustrates another example of the patient overview page 66 where a case manager has selected the vital sign information window 105 for viewing. The window 105 shows specific detail about a selected vital sign. A care manager can select a specific day, specific session of that day, and a particular vital sign that is of interest during that session. For example, such vital sign detail can include a value of the vital sign, a threshold for the vital sign a reading time, and collection details (e.g., device-reported, self-reports, or care-manager reported).

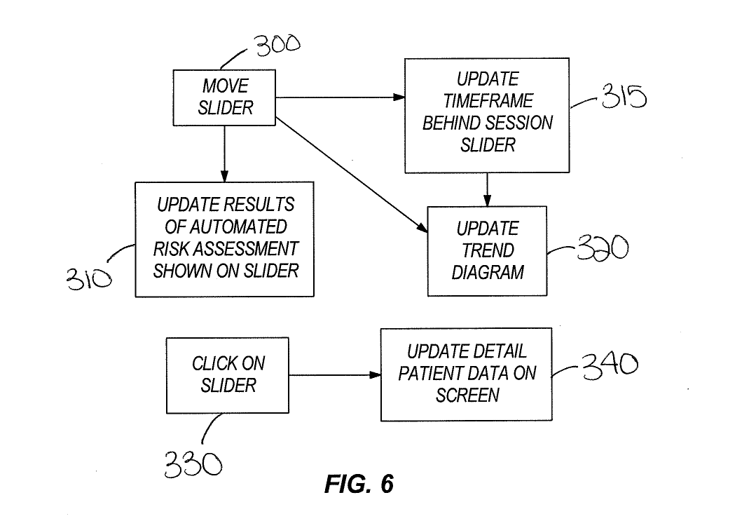

FIG. 6 is a flow diagram illustrating the various processes carried out by the analysis software of the system 10 (e.g., software on the server 30 illustrated in FIG. 1). In one embodiment, the software program includes a plurality of modules or applications that communicate with one another to perform one or more functions of the patient monitoring process such as monitoring, analysis, and evaluation modules or applications (not shown). The software program can transmit instructions to or otherwise communicate with various components of the patient monitoring system 10 and to components and/or systems external to the patient monitoring system 10. The software program also generates the user interface 70 that is presented to the user on the display 65 that is in communication with the network 58. The user interface allows the user to input data into various defined fields to add data, remove data, and/or to change the data. The user interface also allows the user to interact with the software program to select data in one or more of the fields, copy the data, import the data, export the data, select certain applications to run, rerun any one or more of the accessible applications, and perform other functions.

The modules of the analysis software assist with the specific processes related to monitoring the transfer of measuring data between the base station 15 and the workstation 35, analyzing the data to generate the patient's risk assessment, and updating the displayed data on the patient overview page 66 based on commands inputted from the user. As shown in FIG. 6, when a user moves the slider 75 (step 300), the system 10 updates the automated risk assessment shown on the slider 75 (step 310), updates the time frame associated with the session in the slider 75 (step 315), and updates the trend diagram of vital sign displayed in the vital sign trend window 95 (step 320). In addition, when a user clicks on the slider (step 330), the system 10 updates details of the patient data displayed on the screen 65 (step 340).

Thus, the invention provides, among other things, a patient monitoring system that provides a convenient mechanism for analyzing data in the form of a patient history slider. Various features and advantages of the invention are set forth in the following claims.

What is claimed is:

1. A patient monitoring system designed to monitor a patient located in a home or residence and to provide information to a health care manager located at a healthcare facility, the system comprising:
a base station configured to be located at a residence or home of a patient and having an input that receives physiological measurements from a patient;
a computer system located remotely from the patient's home or residence and configured to receive information from the base station over a network, the computer system configured to perform an automated risk assessment of the physiological data, and to generate a graphical user interface having a patient history slider, the computer system further configured to, in response to movement of the slider, update a session time frame, update a trend of physiological measurements, and update the results of an automated risk assessment.

2. The patient monitoring system of claim 1, wherein the computer system is further configured to generate a session risk overview window, a vital sign risk overview window, a vital sign trend window, a session information window, and a vital signs information window as part of the graphical user interface.

3. The patient monitoring system of claim 2, wherein the slider further includes a first row containing a symbol representing whether data was submitted during a session, a symbol representing a critical risk, a symbol representing a medium risk, and a symbol representing a low risk.

4. The patient monitoring system of claim 1, wherein the computer system comprises:
a server located at a facility remote from the patient's home or residence and configured to receive information from the base station over a network;
a workstation located at a healthcare facility and configured to communicate with the server and configured to display the graphical user interface.

5. The patient monitoring system of claim 1, further comprising:
a plurality of physiological data sensors to provide patient data to the base station.

6. A patient monitoring system designed to monitor a patient located in a home or residence and to provide information to a health care manager located at a healthcare facility, the system comprising:
a plurality of physiological data sensors;
base station located at a residence or home of a patient and having an input that receives physiological measurements from one or more sensors;
a network connected to the base station;
a computer system located remotely from the base station and connected to the network, the computer system receiving information from the base station over the network, the computer system performing an automated risk assessment of the physiological data, and generating a graphical user interface having a patient history slider, the computer system, in response to movement of the slider, updating a session time frame, a trend of physiological measurements, and results of an automated risk assessment.

7. The patient monitoring system of claim 6, wherein the computer system generates a session risk overview window, a vital sign risk overview window, a vital sign trend window, a session information window, and a vital signs information window as part of the graphical user interface.

8. The patient monitoring system of claim 7, wherein the slider further includes a first row containing a symbol representing whether data was submitted during a session, a symbol representing a critical risk, a symbol representing a medium risk, and a symbol representing a low risk.

9. The patient monitoring system of claim 1, wherein the computer system comprises:
a server located at a facility remote from the base station;
a workstation located at a healthcare facility communicating with the server and displaying the graphical user interface.
